(19) United States
(12) Patent Application Publication
(10) Pub. No.: US 2018/0215640 A1
(43) Pub. Date: Aug. 2, 2018

(54) System for Treating the Water for a Cooling Tower

(71) Applicant: John D Earman, Vero Beach, FL (US)

(72) Inventor: John D Earman, Vero Beach, FL (US)

(21) Appl. No.: 15/885,700

(22) Filed: Jan. 31, 2018

Related U.S. Application Data
(60) Provisional application No. 62/452,439, filed on Jan. 31, 2017.
(60) Provisional application No. 62/469,093, filed on Mar. 9, 2017.

(51) Int. Cl. C02F 9/00

(52) U.S. Cl. CPC C02F 9/00; C02F 2101/203

(57) ABSTRACT

A system for treating the water for a cooling tower uses a primary treatment system, a flow control valve, a tower basing, and a side-stream filtration system to remove unwanted qualities from the water that flows through the cooling tower. The primary treatment system is a filtration system that has a back-flushing media filter and a water softener. Similarly, the side-stream filtration system is a filtration system used to agitate the water within the tower basin, and to remove biological materials and sediment. Raw water is supplied to the primary treatment system, is filtered, and then passes through the flow control valve before being deposited into the tower basin. The majority of the water in the tower basin flows into a connected chiller. However, a portion of the water in the tower basin is passed through the side-stream filtration system before being deposited back into the tower basin.

The current application claims a priority to the U.S. Provisional Patent application Ser. No. 62/452,439 filed on Jan. 31, 2017 and a priority to the U.S. Provisional Patent application Ser. No. 62/469,093 filed on Mar. 9, 2017.

### FIELD OF THE INVENTION

The present invention relates generally to a water treatment system. More specifically, the present invention is a system that monitors and treats the water in a water cooling tower to increase system efficiency and prevent corrosion.

### BACKGROUND OF THE INVENTION

The present invention relates to the treatment of water in, for example, a water cooling system such as that employed in the air conditioning apparatus of an industrial building. Such systems commonly include heat exchangers through which cooling water flows, the water being cooled by partial evaporation in air as the water falls by gravity within a cooling tower which is usually mounted on the roof of the building or in close proximity to Central Energy Plants (CEPs).

Four main impurity problems are encountered in the treatment of water in cooling systems including a cooling tower. The first significant problem is fouling of the system which is caused by the growth of algae and slime caused by bacteria and fungi. Such fouling reduces both water flow and heat transfer efficiency. The second significant impurity problem is corrosion. Over a period of time, corrosion due to organic secretion and decay necessitates extensive repair and replacement of costly equipment. The third significant impurity problem is microbiological activity. Certain contaminants in the system may be organic and support the growth of microorganisms, including pathogens such as Legionella that may be released from the cooling tower into the atmosphere. The fourth significant impurity problem, and by far the most common problem, is scaling. Scaling is caused by the deposition of dissolved minerals on the cooling tower baffles and particularly on the hot surface areas in the condenser tubes of the heat exchanger where heat transfer is most important.

The invention provides methods and systems to reduce the amount of fouling, corrosion, microbiological activity, and scaling in a water treatment system by combining multiple water treatments into a water treatment system. Water treatment is achieved by components that include back-flushing media filters, water softener systems, side stream sediment filtration systems, sacrificial anode systems, and chlorine treatment systems.

In one embodiment of the invention, the water treatment system may include three treatment components. For example, in one embodiment of the invention, the water treatment system may include a back-flushing media filter, a side stream sediment filtration system, and a chlorine treatment system. In another embodiment of the invention, the water treatment system may include a back-flushing media filter, a water softener system, and a side stream sediment filtration system.

In another embodiment of the invention, the water treatment system may include four treatment components. For example, in one embodiment the water treatment system may include a back-flushing media filter, a water softener, a side stream sediment filtration system, and a sacrificial anode system. In still another embodiment, the water treatment system may include a back-flushing media filter, a water softener, a side stream sediment filtration system, and a chlorine treatment system.

In a preferred embodiment of the invention, the water treatment system may include five treatment components. Specifically, the water treatment system may include a back-flushing media filter, a water softener, a side stream sediment filtration system, a sacrificial anode system, and a chlorine treatment system.

In another embodiment of the invention, metal plates or “coupons” are placed in the pipes that supply the water to the chiller plant for the purpose of monitoring the extent of metallurgic erosion in the entire CEP. The coupons can be removed any analyzed periodically to determine the extent of corrosion of the metal components in the CEP and to generate and estimate the remaining lifespan of the CEP.

Another embodiment of the invention is directed to a method of treating water in a water treatment system by combining three or more treatments. The treatments are achieved by three or more of the following treatment components: a back-flushing media filter, a water softener system, a side stream sediment filtration system, a sacrificial anode system, and a chlorine treatment system. For example, in one embodiment the water is treated with a back-flushing media filter, a side stream sediment filtration system, and a sacrificial anode system. In another embodiment, the water is treated with a back-flushing media filter, a side stream sediment filtration system, a sacrificial anode system, and a chlorine treatment system. In a further embodiment, the water is treated with a back-flushing media filter, a water softener system, a side stream sediment filtration system, a sacrificial anode system, and a chlorine treatment system.

Another embodiment of the invention provides a method of reducing fouling, corrosion, microbiological activity, or scaling in a water treatment system by combining three or more treatments. The treatments are achieved by three or more of the following water treatment components: a back-flushing media filter, a water softener system, a side stream sediment filtration system, a sacrificial anode system, and a chlorine treatment system.

A further embodiment of the invention is directed to a method of increasing the lifespan of a water treatment system by combining three or more treatments. The treatments are achieved by three or more of the following treatment components: a back-flushing media filter, a water softener system, a side stream sediment filtration system, a sacrificial anode system, and a chlorine treatment system.

An additional embodiment of the invention is directed to a method of controlling the power consumption of a water treatment system by combining three or more treatments. The treatments are achieved by three or more of the following treatment components: a back-flushing media filter, a water softener system, a side stream sediment filtration system, a sacrificial anode system, and a chlorine treatment system.

### BRIEF DESCRIPTION OF THE DRAWINGS

FIG. 1 is a block diagram showing the connections between the components of the system of present invention, where solid arrows represent the direction of flow in a fluid communication connection and dashed arrows represent electronic communication.

FIG. 2 is a block diagram showing the connections between the components of the primary treatment system of present invention.

FIG. 3 is a block diagram showing the connections between the components of the side-stream filtration system of present invention.

FIG. 4 is a block diagram showing the connections between the components of the secondary treatment system of present invention.

FIG. 5 is a block diagram showing the connections between the components of the secondary treatment system of present invention, where the secondary treatment system further comprises a corrosion coupon rack and is connected to a plurality of sensors.

### DETAIL DESCRIPTIONS OF THE INVENTION

All illustrations of the drawings are for the purpose of describing selected versions of the present invention and are not intended to limit the scope of the present invention.

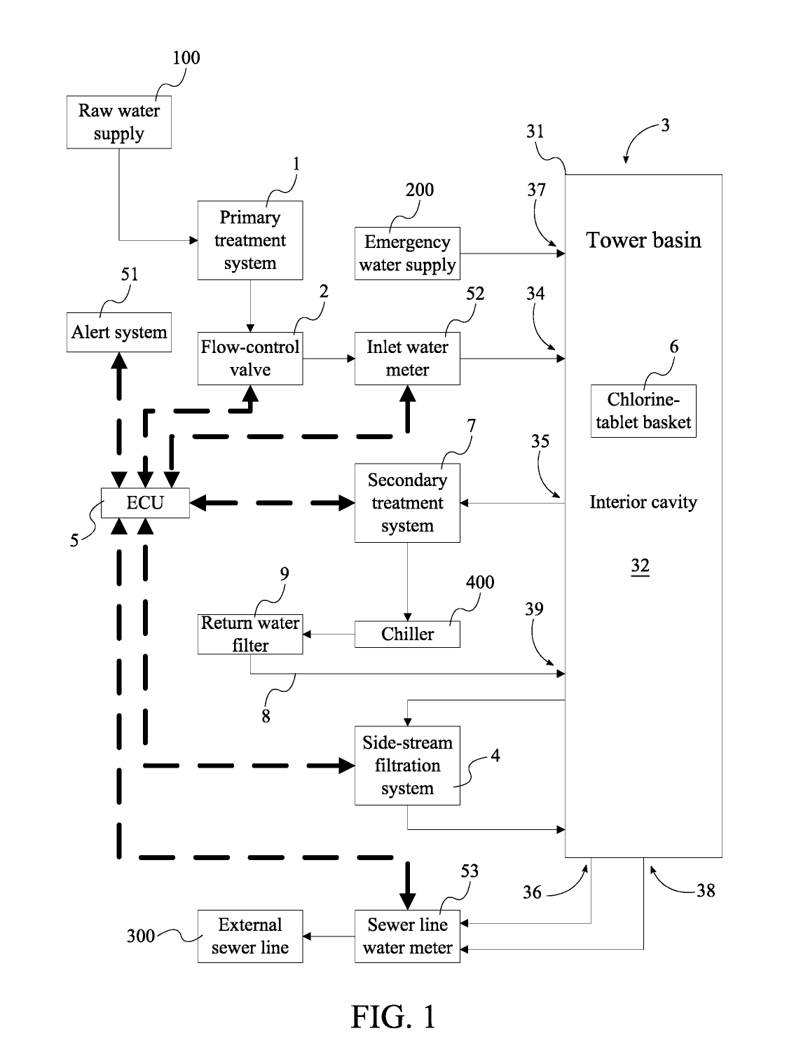

Referring to FIG. 1 through FIG. 5, the present invention, a system for treating the water for a cooling tower, is a system that is used to remove contaminants from a fluid that is pumped through a cooling tower. Additionally, the system of the present invention is used to monitor and modify qualities of the fluid that include, but are not limited to, conductivity, rate of flow, biological material concentration, and total dissolved solids. Preferably, the system of the present invention is integrated into the cooling water supply system that transfers water between the tower basin and the chiller of the water cooling system. The water in the present invention is directed to flow from an external water supply 100, or raw water supply 100, through the filtration and treatment systems of the present invention, and into the chiller 400 of the water cooling system. To treat the water that flows through the water cooling system, the present invention comprises a primary treatment system 1, a flow-control valve 2, a tower basin 3, and a side-stream filtration system 4. Expounding on the description of the water flow, raw water is first supplied to the system from an external water supply 100. Raw water from the external water supply 100 is filtered as it passes through the primary treatment system 1 and then moved into the tower basin 3 through the float-control valve. To accomplish this, the primary treatment system 1 is a filtration and water modification system that treats the raw water before the raw water is deposited into the tower basin 3. Additionally, the primary treatment system 1 comprises a back-flushing media filter 11 and a water softener 12.

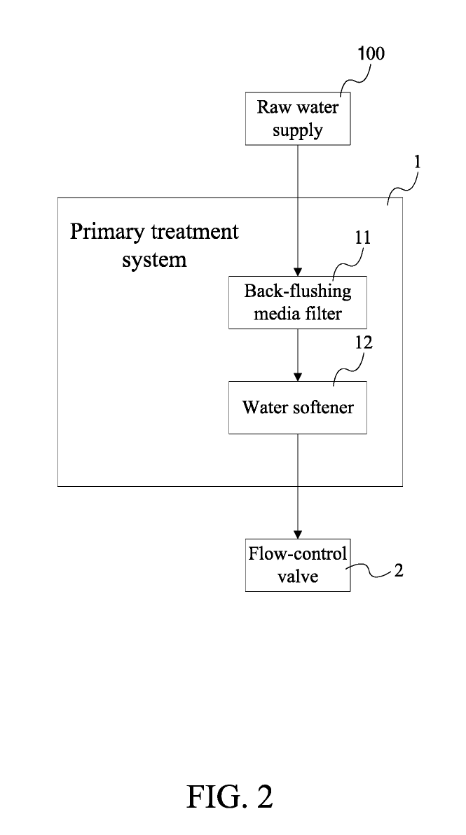

Referring to FIG. 1 and FIG. 2, the back-flushing media filter 11 is a device that removes heavy cations that include, but are not limited to, iron, calcium, and magnesium. The back-flushing media filter 11 is chosen, in accordance with well understood principles, such as filter size, materials, etc., to be appropriate to enable the required precipitates to be separated from the main body of the water. Examples of back-flushing media filters 11 that can be used include, but are not limited to, green sand, charcoal, diatomaceous earth, and plain sand back-flushing media filters 11. The raw water flows through the back-flushing media filter 11 and into the water softener 12. The back-flushing media filter 11 removes heavy cations and lowers the amount of calcium bicarbonate in the water. Thus, preventing scaling in the water cooling system into which the system of the present invention is integrated. Additionally, the back-flushing media filter 11 lowers the total conductivity of the water on a volume basis, which in turn increases the dilution potential by reducing the total number of suspended molecules and compounds in the water. This ultimately leads to an increase in the number of recirculating cycles that the water can undergo when it reaches the cooling tower.

Referring to FIG. 1 and FIG. 2, after passing through the back-flushing media filter 11, the water then passes through the water softener 12. The water softener 12 is a device that removes the hardness from water, usually by means of ion exchange. By partially softening the water using an ion exchange resin, the system of the present invention yields an overall reduction in the amount of calcium in the resulting water, hereinafter referred to as normal make-up water. Sodium does not cause scaling to occur. An additional water softener 12 system that may be used in certain circumstances is a reverse osmosis filter. Reverse osmosis filters are generally used in high salinity areas.

Referring to FIG. 1, the tower basin 3 is a container that holds the water that flows through the water cooling system. As such, the tower basin 3 is placed in fluid communication with various components of the system of the present invention. To accomplish this the tower basin 3 comprises a basin body 31, an interior cavity 32, a water-supply inlet 34, a chiller-supply outlet 35, and a sewer line outlet 36. The basin body 31 is a rigid structure that the defines the structure of the tower basin 3. Additionally, the interior cavity 32 is positioned within the basin body 31 so that water can be stored within the tower basin 3. The water-supply inlet 34, the chiller-supply outlet 35, and the sewer line outlet 36 are valves that can control the flow of a fluid. The present invention makes use of such valves to enable water to flow into and out of the interior cavity 32. Specifically, the water-supply inlet 34, the chiller-supply outlet 35, and the sewer line outlet 36 are integrated into the basin body 31 and in fluid communication with the interior cavity 32.

Referring to FIG. 1 and FIG. 2, the flow of water from the primary treatment system 1 into the interior cavity 32 is controlled by the flow-control valve 2. The flow-control valve 2 is preferably a float valve that is integrated into the tower basin 3 and is governed by the amount of water that is stored within the interior cavity 32. Accordingly, the water levels in the interior cavity 32 are controlled by the float valve. When the needs of the cooling tower are not being met by the normal makeup water, raw makeup water can be added to the cooling tower from an emergency water supply 200. When this occurs, an alarm may be triggered that is sent to an operator. Additionally, the back-flushing media filter 11 is in fluid communication with the flow-control valve 2 through the water softener 12. Further, water softener 12 is in fluid communication with the water-supply inlet 34 through the flow-control valve 2. As a result, the flow of the normal make up water into the interior cavity 32 is controlled by the flow-control valve 2. Specifically, water from the external water supply 100 must pass through the back-flushing media filter 11, the water softener 12, and the flow-control valve 2 before passing through the water-supply inlet 34 and into the interior cavity 32.

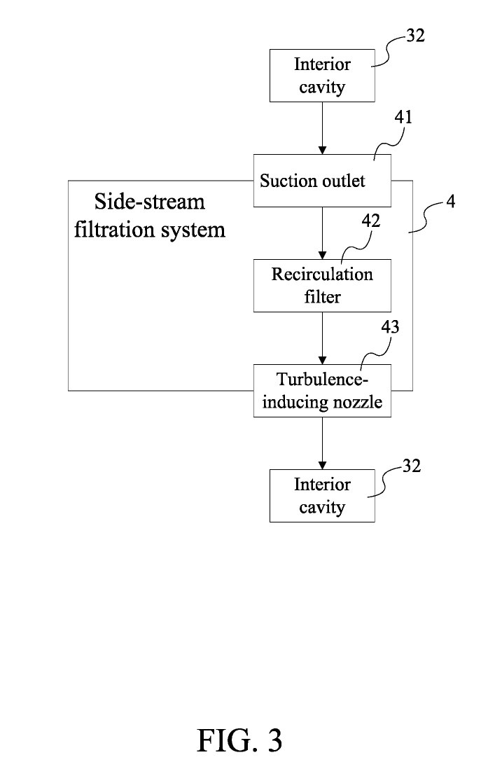

Referring to FIG. 1 and FIG. 3, one component of the water treatment system is the side-stream filtration system 4 that is connected to the tower basin 3. The side-stream filtration system 4 is a recirculation system that removes impurities from the water within the interior cavity 32. To accomplish this, the side-stream filtration system 4 comprises a suction outlet 41, a recirculation filter 42, and a turbulence-inducing nozzle 43. The suction outlet 41 is a valve that is integrated into the basin body 31 and in fluid communication with the interior cavity 32. Likewise, the turbulence-inducing nozzle 43 is integrated into the basin body 31 and in fluid communication with the interior cavity 32. Preferably, the turbulence-inducing nozzle 43 is a Venturi-effect nozzle discharge system that causes turbulence in the water within the interior cavity 32. The recirculation filter 42 is a pumping device. Additionally, the recirculation filter 42 moves water into the side-stream filtration system 4 by pulling water through the suction outlet 41, filtering the water, and then dispensing the filtered water back into the interior cavity 32 through the turbulence-inducing nozzle 43. In the side-stream filtration system 4, a small portion (15-20%) of the water in the interior cavity 32 is continuously filtered and returned to the system to remove suspended solids from cooling tower systems. The operation of the side-stream filtration system is preferably controlled by an automation system and is adjusted for water turbidity and sediment. The use of a side-stream filtration system 4 leads to less fouling in the system of the present invention, as well as a reduction in biological growth in the system of the present invention. There are a variety of filter types that can be used. They generally fall into the following three basic categories: screen filters, centrifugal filters, and multi-media filters.

Referring to FIG. 1 and FIG. 3, the system of the present invention is designed to perform automated monitoring, control, and alert functions. Accordingly, the system of the present invention further comprises an electronic control unit (ECU) 5. The ECU 5 is a computing device capable of connecting to and controlling the electronic components of the system of the present invention. Specifically, the ECU 5 is electronically connected to the flow-control valve 2 and the recirculation filter 42. As a result, the ECU 5 can control the flow of water through the water-supply inlet 34. Additionally, the ECU 5 governs the operations of the side-stream filtration system 4.

Referring to FIG. 1, the system of the present invention is designed to monitor the flow of water through the water cooling system and to generate alerts whenever an abnormal event is detected. To accomplish this, the system of the present invention further comprises an alert system 51, an inlet water meter 52, and a sewer line water meter 53. The alert system 51 is an electronic device capable of communicating with external devices and generating system status alerts. Additionally, the alert system 51 can be communicated with via both wired and wireless connections. Furthermore, the alert system 51 can output both visual and audible alerts. The alert system 51, the inlet water meter 52, and the sewer line water meter 53 are electronically connected to the ECU 5. Consequently, the ECU 5 can direct the alert system 51 to generate alerts based on information gathered from the inlet water meter 52 and the sewer line water meter 53. The flow-control valve 2 is in fluid communication with the water-supply inlet 34 through the inlet water meter 52. Thus connected, the inlet water meter 52 is able to measure the volume of water that flows into the interior cavity 32. Similarly, the sewer line outlet 36 is in fluid communication with an external sewer line 300 through the sewer line water meter 53. Thus connected, the sewer line water meter 53 is able to measure the volume of water that is discharged into the external sewer line 300. The information that is gathered by the inlet water meter 52 and the sewer line water meter 53 is transferred to the ECU 5 and used to chart the amount of water that is discharged into the external sewer line 300 vs the amount of water that was provided by the raw water supply 100.

Referring to FIG. 1, the system of the present invention is designed with failsafe mechanisms that prevent the system from being damaged during abnormal working conditions. Specifically, the system of the present invention further comprises an emergency inlet valve 37 and an overflow valve 37. The emergency inlet valve 37 is used to provide additional water to the interior cavity 32 when the normal make up water is not being supplied at a sufficient rate. Relatedly, the overflow valve 37 is used to dispense water from the interior cavity 32 when the water level within the interior cavity 32 exceeds a predefined threshold. To accomplish this, the emergency inlet valve 37 and the overflow valve 37 are integrated into the basin body 31 and in fluid communication with the interior cavity 32. Additionally, the emergency water supply 200 is in fluid communication with the interior cavity 32 through the emergency inlet valve 37 so that the emergency water supply 200 can dispense water into the interior cavity 32 when the emergency inlet valve 37 is opened. Similarly, the interior cavity 32 is in fluid communication with an external sewer line 300 through the overflow valve 37. Accordingly, the interior cavity 32 can dispense water into the external sewer line 300 when the overflow valve 37 is opened. Preferably, the emergency inlet valve 37 is in fluid communication with the inlet water meter 52 so that the ECU 5 is able to record the amount of water that is supplied by the emergency water supply 200. Similarly, the overflow valve 37 is in fluid communication with the sewer line water meter 53 so that the ECU 5 is able to record the amount of water that is dispensed into the external sewer line 300 through the overflow valve 37. Additionally, both the emergency inlet valve 37 and the overflow valve 37 may be electronically connected to the ECU 5. As a result, the ECU 5 is able to control when the two valves open and close.

Referring to FIG. 1 and FIG. 3, as described above, the side-stream filtration system 4 is used to remove impurities from the interior cavity 32. Specifically, the side-stream filtration system 4 is designed to agitate the water that is positioned within a bottom portion of the interior cavity 32 and then filter out unwanted sediments and biological materials. To accomplish this, the suction outlet 41 and the turbulence-inducing nozzle 43 are positioned adjacent to a base of the interior cavity 32. Additionally, the turbulence-inducing nozzle 43 is positioned offset from the suction outlet 41, about the interior cavity 32. Thus positioned, the suction outlet 41 and the turbulence-inducing nozzle 43 create a turbulent flow in the base of the interior cavity 32.

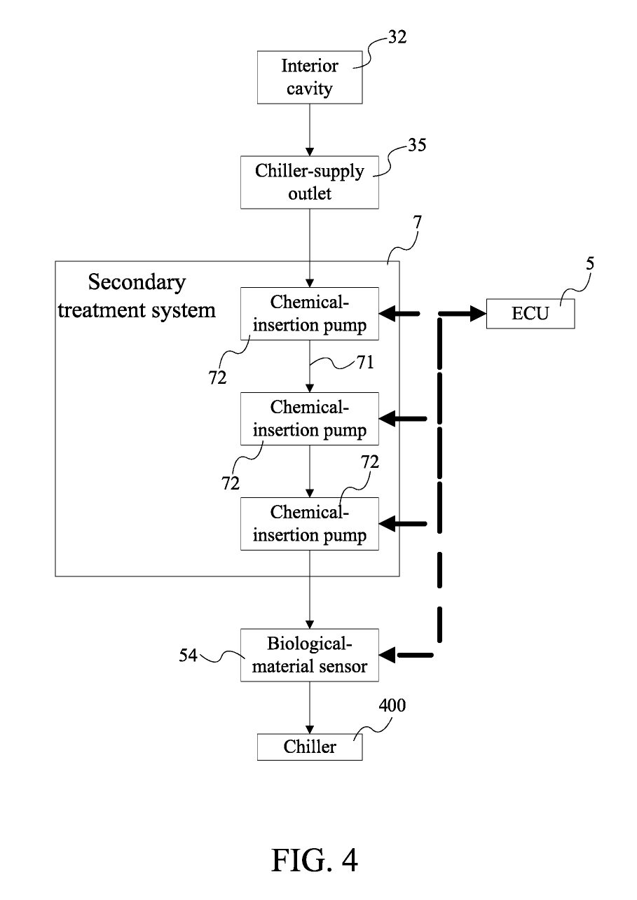

Referring to FIG. 1 and FIG. 4, the system of the present invention is designed to modify the water that flows through the water cooling system, such that corrosion and biofouling are reduced. To accomplish this, the system of the present invention further comprises a chlorine-tablet basket 6 and a secondary treatment system 7. The chlorine-tablet basket 6 is a floating container that holds water treatment chemicals that include, but are not limited to, chlorine tablets, biocide tablets, and bromine tablets. Additionally, the chlorine-tablet basket 6 is mounted within the interior cavity 32, such that the chlorine-tablet basket 6 floats on the surface of the water within the interior cavity 32. The secondary treatment system 7 is an additional treatment system that further modifies the water that is dispensed from the interior cavity 32, before the water is delivered to the water to the chiller 400. As such, the secondary treatment system 7 is in fluid communication with the chiller-supply outlet 35. As a result, water that flows through the chiller-supply outlet 35 must first pass through the secondary treatment system 7, before entering the chiller. The secondary treatment system 7 is electronically connected to the ECU 5 so that the ECU 5 can monitor and control the operations of the secondary treatment system 7.

Referring to FIG. 1 and FIG. 4, one function of the secondary treatment system 7 is to act as a chemical feed system that modifies the water before it is supplied to the chiller 400. To achieve this, the secondary treatment system 7 comprises a chiller-supply line 71 and a plurality of chemical-insertion pumps 73. Additionally, the system of present invention comprises a biological-material sensor 54. The biological-material sensor 54 is a device that detects the presence of biological material, or alternatively the presence of biocide markers. The chemical-insertion pumps 73 are in fluid communication with the chiller-supply line 71 so that the plurality of chemical-insertion pumps 73 is able to inject chemicals into the water that is flowing through the chiller-supply line 71. Likewise, the biological-material sensor 54 is in fluid communication with the chiller-supply line 71. Consequently, the biological-material sensor 54 is able to detect the presence of biological materials and chemical markers. Preferably, the plurality of chemical-insertion pumps 73 includes three pulse pumps that contain chemicals which include, but are not limited to, a buffer, various biocides, an oxidizing biocide, and a nonoxidizing biocide. Optionally, a marker chemical, for example, a florescent chemical, is placed in the buffer and in the biocides before the buffer and the biocides are injected into the system. The chemical-insertion pumps 73 and the biological-material sensor 54 are electronically connected to the ECU 5. Consequently, the ECU 5 is able to monitor and control the chemical-insertion pumps 73 and the biological-material sensor 54. For example, the ECU 5 can direct the alert system 51 to generate am alarm, if the levels of the chemical markers fall below a certain threshold.

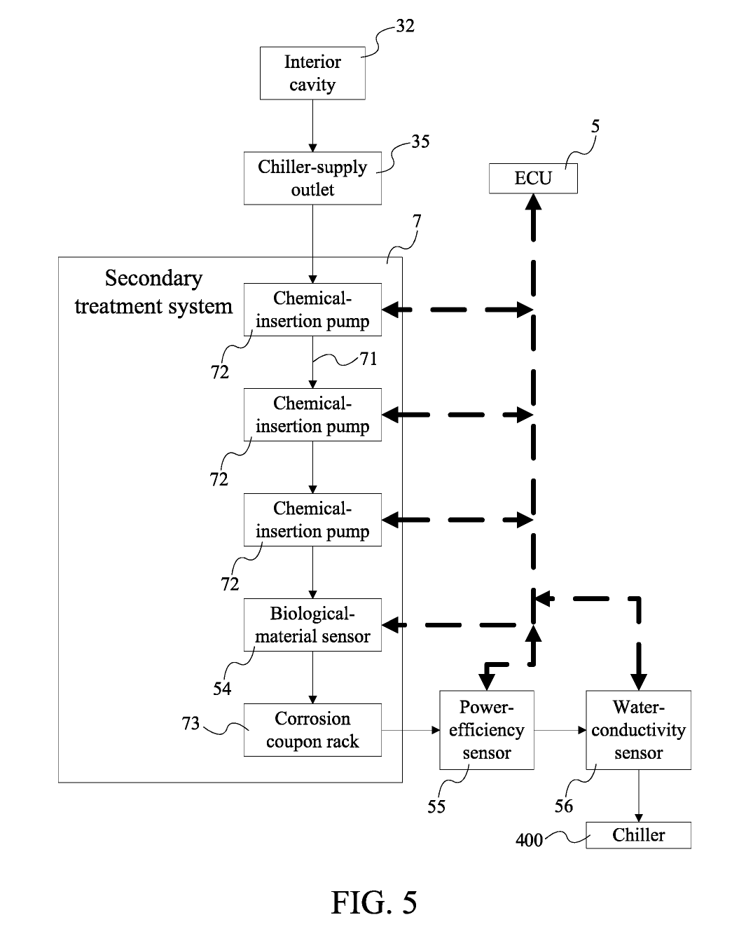

Referring to FIG. 1 and FIG. 5, an additional function of the secondary treatment system 7 is to monitor the presence of corrosive and conductivity-increasing materials. To accomplish this, the system of the present invention further comprises a power-efficiency sensor 55 and a water-conductivity sensor 56. Additionally, the secondary treatment system 7 further comprises a corrosion coupon rack 73. The power-efficiency sensor 55 and the water-conductivity sensor 56 are in fluid communication with the chiller-supply line 71 so that the two sensors are able to determine the power efficiency and the water conductivity of the system of the present invention. The power-efficiency sensor 55 and the water-conductivity sensor 56 are electronically connected to the ECU 5. As a result, the ECU 5 is able to monitor and control the power-efficiency sensor 55 and the water-conductivity sensor 56. For example, the ECU 5 can direct the alert system 51 to generate am alarm, if the water conductivity reaches a set point above 3000 microseimens. Preferably, the water-conductivity sensor 56 is connected to a blowdown system in order to maintain water conductivity at a level below 2400 microseimens.

Referring to FIG. 1 and FIG. 5, in addition to sensing various characteristics of the water within the chiller-supply line 71, the secondary treatment system 7 is able to measure the buildup of scale and corrosion damage within the components of the water cooling system. The corrosion coupon rack 73 is in fluid communication with the chiller-supply line 71 so that a user may easily ascertain the buildup of scale and corrosion damage within the water cooling system. Specifically, the chiller-supply line 71 is monitored using metal plates or “coupons” present on a corrosion coupon rack 73. The coupons can be made from materials including, but not limited to, steel, aluminum, and copper. The coupons can be periodically removed from the system, e.g., every month, every two months, or preferably every three months, and then analyzed to determine the erosion rate of the various metal components in the water cooling system. The coupons can be analyzed by methods known in the art to generate an estimate of the remaining lifespan of the water cooling system.

Referring to FIG. 1, the system of the present invention is designed to recirculate water from the chiller 400 back into the interior cavity 32 of the tower basin 3. However, the water that returns from the chiller 400 may contain unwanted particles that must be removed. To accomplish this, the system of the present invention comprises a return-water line 8 and a return-water filter 9. Additionally, the tower basin 3 further comprises a return-water inlet 39. The return-water inlet 39 is integrated into the basin body 31 and in fluid communication with the interior cavity 32. The return-water filter 9 is in fluid communication with the interior cavity 32 through the return-water inlet 39. Further, the return-water line 8 is in fluid communication with the return-water inlet 39 through the return-water filter 9. As a result, water that is dispensed from the chiller 400 must pass through the return-water filter 9, before entering the interior cavity 32. The return-water filter 9 is preferably a Y-strainer which protects the pumps in the system from large debris. Additionally, the return-water filter 9 includes a sacrificial anode. For example, depending on the CEP, the sacrificial anode can be made of materials that include, but are not limited to, zinc, magnesium, or aluminum. The sacrificial anode provides a desired degree of protection against corrosion. For example, when a zinc sacrificial anode is used, the zinc combines with phosphates to form zinc orthophosphate. Zinc orthophosphate is a strong anti-corrosion molecule. Additionally, zinc sacrificial anodes have an electrical potential that causes them to corrode before other parts of the system.

Although the invention has been explained in relation to its preferred embodiment, it is to be understood that many other possible modifications and variations can be made without departing from the spirit and scope of the invention as hereinafter claimed.

What is claimed is:

1. A system for treating the water for a cooling tower comprises:
a primary treatment system;
a flow-control valve;
a tower basin;
a side-stream filtration system;
the primary treatment system comprises a back-flushing media filter and a water softener;
the side-stream filtration system comprises a suction outlet, a recirculation filter, and a turbulence-inducing nozzle;
the tower basin comprises a basin body, an interior cavity, a water-supply inlet, a chiller-supply outlet, and a sewer line outlet;
the interior cavity being positioned within the basin body;
the water-supply inlet, the chiller-supply outlet, and the sewer line outlet being in fluid communication with the interior cavity;
the back-flushing media filter being in fluid communication with the flow-control valve through the water softener;
the water softener being in fluid communication with the water-supply inlet through the flow-control valve;
the suction outlet being in fluid communication with the interior cavity;
the turbulence-inducing nozzle being in fluid communication with the interior cavity; and
the suction outlet being in fluid communication with the turbulence-inducing nozzle through the recirculation filter.

2. The system for treating the water for a cooling tower as claimed in claim 1 comprises:
an electronic control unit (ECU); and
the ECU being electronically connected to the flow control valve and the recirculation filter.

3. The system for treating the water for a cooling tower as claimed in claim 2 comprises:
an alert system;
an inlet water meter;
a sewer line water meter;
the flow-control valve being in fluid communication with the water-supply inlet through the inlet water meter;
the sewer line outlet being in fluid communication with an external sewer line through the sewer line water meter; and
the alert system, the inlet water meter, and the sewer line water meter being electronically connected to the ECU.

4. The system for treating the water for a cooling tower as claimed in claim 1 comprises:
an emergency inlet valve;
the emergency inlet valve being in fluid communication with the interior cavity; and
an emergency water supply being in fluid communication with the interior cavity through the emergency inlet valve.

5. The system for treating the water for a cooling tower as claimed in claim 1 comprises:
an overflow valve;
the overflow valve being in fluid communication with the interior cavity; and
the interior cavity being in fluid communication with an external sewer line through the overflow valve.

6. The system for treating the water for a cooling tower as claimed in claim 1 comprises:
the suction outlet and the turbulence-inducing nozzle being positioned adjacent to a base of the interior cavity; and
the turbulence-inducing nozzle being positioned offset from the suction valve, about the interior cavity.

7. The system for treating the water for a cooling tower as claimed in claim 1 comprises:
a chlorine-tablet basket; and
the chlorine-tablet basket being mounted within the interior cavity.

8. The system for treating the water for a cooling tower as claimed in claim 1 comprises:
an ECU;
a secondary treatment system;
the secondary treatment system being in fluid communication with the chiller-supply outlet; and
the secondary treatment system being electronically connected to the ECU.

9. The system for treating the water for a cooling tower as claimed in claim 8 comprises:
a biological-material sensor;
the secondary treatment system comprises a chiller-supply line and a plurality of chemical-insertion pumps;
the chiller-supply line being in fluid communication with the chiller-supply outlet;
the chemical-insertion pumps being in fluid communication with the chiller-supply line;
the biological-material sensor being in fluid communication with the chiller-supply line; and
the chemical-insertion pumps and the biological-material sensor being electronically connected to the ECU.

10. The system for treating the water for a cooling tower as claimed in claim 8 comprises:
a power-efficiency sensor;
a water-conductivity sensor;
the secondary treatment system comprises a chiller-supply line and a corrosion coupon rack;
the chiller-supply line being in fluid communication with the chiller-supply outlet;
the power-efficiency sensor and the water-conductivity sensor being in fluid communication with the chiller-supply line;
the corrosion coupon rack being in fluid communication with the chiller-supply line; and
the power-efficiency sensor and the water-conductivity sensor being electronically connected to the ECU.

11. The system for treating the water for a cooling tower as claimed in claim 1 comprises:
a return-water line;
a return-water filter;
the tower basin further comprises a return-water inlet;
the return-water inlet being in fluid communication with the interior cavity;
the return-water filter being in fluid communication with the interior cavity through the return-water inlet; and
the return-water line being in fluid communication with the return-water inlet through the return-water filter.

12. A system for treating the water for a cooling tower comprises:
a primary treatment system;
a flow-control valve;
a tower basin;
a side-stream filtration system;
an electronic control unit (ECU);
a secondary treatment system;
the primary treatment system comprises a back-flushing media filter and a water softener;
the side-stream filtration system comprises a suction outlet, a recirculation filter, and a turbulence-inducing nozzle;
the tower basin comprises a basin body, an interior cavity, a water-supply inlet, a chiller-supply outlet, and a sewer line outlet;
the interior cavity being positioned within the basin body;
the water-supply inlet, the chiller-supply outlet, and the sewer line outlet being in fluid communication with the interior cavity;
the back-flushing media filter being in fluid communication with the flow-control valve through the water softener;
the water softener being in fluid communication with the water-supply inlet through the flow-control valve;
the suction outlet being in fluid communication with the interior cavity;
the turbulence-inducing nozzle being in fluid communication with the interior cavity;
the suction outlet being in fluid communication with the turbulence-inducing nozzle through the recirculation filter;
the secondary treatment system being in fluid communication with the chiller-supply outlet; and
the ECU being electronically connected to the flow control valve, the recirculation filter, and the secondary treatment system.

13. The system for treating the water for a cooling tower as claimed in claim 12 comprises:
an alert system;
an inlet water meter;
a sewer line water meter;
the flow-control valve being in fluid communication with the water-supply inlet through the inlet water meter;
the sewer line outlet being in fluid communication with an external sewer line through the sewer line water meter; and
the alert system, the inlet water meter, and the sewer line water meter being electronically connected to the ECU.

14. The system for treating the water for a cooling tower as claimed in claim 12 comprises:
an emergency inlet valve;
the emergency inlet valve being in fluid communication with the interior cavity; and
an emergency external water supply 100 being in fluid communication with the interior cavity through the emergency inlet valve.

15. The system for treating the water for a cooling tower as claimed in claim 12 comprises:
an overflow valve;
the overflow valve being in fluid communication with the interior cavity; and
the interior cavity being in fluid communication with an external sewer line through the overflow valve.

16. The system for treating the water for a cooling tower as claimed in claim 12 comprises:
the suction outlet and the turbulence-inducing nozzle being positioned adjacent to a base of the interior cavity; and
the turbulence-inducing nozzle being positioned offset from the suction valve, about the interior cavity.

17. The system for treating the water for a cooling tower as claimed in claim 12 comprises:
a chlorine-tablet basket; and
the chlorine-tablet basket being mounted within the interior cavity.

18. The system for treating the water for a cooling tower as claimed in claim 12 comprises:
a biological-material sensor;
the secondary treatment system comprises a chiller-supply line and a plurality of chemical-insertion pumps;
the chiller-supply line being in fluid communication with the chiller-supply outlet;
the chemical-insertion pumps being in fluid communication with the chiller-supply line;
the biological-material sensor being in fluid communication with the chiller-supply line; and
the chemical-insertion pumps and the biological-material sensor being electronically connected to the ECU.

19. The system for treating the water for a cooling tower as claimed in claim 12 comprises:
a power-efficiency sensor;
a water-conductivity sensor;
the secondary treatment system comprises a chiller-supply line and a corrosion coupon rack;
the chiller-supply line being in fluid communication with the chiller-supply outlet;
the power-efficiency sensor and the water-conductivity sensor being in fluid communication with the chiller-supply line;
the corrosion coupon rack being in fluid communication with the chiller-supply line; and
the power-efficiency sensor and the water-conductivity sensor being electronically connected to the ECU.

20. The system for treating the water for a cooling tower as claimed in claim 12 comprises:
a return-water line;
a return-water filter;
the tower basin further comprises a return-water inlet;
the return-water inlet being in fluid communication with the interior cavity;
the return-water filter being in fluid communication with the interior cavity through the return-water inlet; and
the return-water line being in fluid communication with the return-water inlet through the return-water filter.
